(19) United States
(12) Patent Application Publication
(10) Pub. No.: US 2004/0243972 A1
(43) Pub. Date: Dec. 2, 2004

(54) Method for wiring automation functions in an installation and method for requesting and modifying wiring data

(76) Inventor: Michael Schlereth, Wilhermsdorf (DE)

Correspondence Address: Siemens Corporation, Intellectual Property Department, 170 Wood Avenue South, Iselin, NJ, 08830, US

(21) Appl. No.: 10/488,959

(22) PCT Filed: Aug. 28, 2002
(86) PCT No.: PCT/DE02/03153

(30) Foreign Application Priority Data
Sep. 10, 2001 (DE) 101444273

(51) Int. Cl. G06F 9/44

(52) U.S. Cl. 717/104

(57) ABSTRACT

The invention concerns a method and a system for wiring automation functions in an installation, whereby a client programme transmits a file in a markup language to an installation server computer over a network. The file describes the wiring of automation functions in a markup language. Said file is interpreted by a programme of the installation server computer, said programme subsequently generating instructions for the components and which are transmitted over the network. Said instructions are used to implement the wiring specified by the file in the components. Furthermore, it is possible to modify the file on the client computer to modify the wiring.

### CROSS REFERENCE TO RELATED APPLICATIONS

This application is the US National Stage of International Application No. PCT/DE02/03153, filed Aug. 28, 2002 and claims the benefit thereof. The International Application claims the benefits of German application No. 10144427.3 filed Sep. 10, 2001, both of the applications are incorporated by reference herein in their entirety.

### FIELD OF INVENTION

The invention relates to a method for wiring automation functions in a system and a method for requesting and modifying wiring information.

### BACKGROUND OF INVENTION

It is known per se from the prior art that a control system, for example a Programmable Logic Controller (PLC), can be connected to a system server which can be accessed by a client computer. The client computer can also load html pages from the server computer, for example to display process values at a user interface. The link between an output field of the html page and the process value is programmed in such cases as a permanent link using a JAVA script or by means of OCX (OLE Control Extension).

A system for remote access to a controller system via a commercial communications network is known from U.S. Pat. No. 6,061,603. FIG. 1 shows a block diagram of this previously known system.

The system includes a Personal Computer 8 with a Browser program 10. The Browser 10 can be a commercially available Internet browser such as for example Netscape Communication Navigator or Microsoft Internet Explorer. The browser program 10 is used to access a Web site 4 over the Internet 14 to display the content of the Web site 4 on the monitor 12 of the Personal Computer 8 for a user 2.

The Web site 4 includes a network interface 16 with a unique Internet address 18 as well as a server computer 20 and an application program 22. The server 20 is used for interpreting HTTP protocols and uses TCP/IP via TCP/IP stack 24 to interact with the network interface 16 and the application program 22. This allows data to be transferred between the application program 22 and the user 2 over the Internet 14.

The application program 22 delivers data from a controller system 6. This data can be used for monitoring of controller by user 2 since this data can be transmitted by means of the TCP/IP stack 24 from Web site 4 over the Internet 14 to the Personal Computer 8 of user 2. This creates a man-machine interface on Personal Computer 8.

User 2 can establish a connection via the Internet 14 using an Internet Service Provider and then enter the address of the Web site 4 into the Browser program 10. User 2 can then use browser 10 for example to read a home page of Web site 4 and retrieve information from it. As a result of an input by user 2 browser 10 sends commands to Web site 4 which the application program 22 uses to display information made available by controller system 6. The disadvantage of this previously known system is especially that application program 22 must be programmed specifically for a particular controller system 6 and does not allow any flexibility.

Another disadvantage of such a previously known system is that the wiring information of the components of the controller systems has fixed coding and must be created by a special program. Special design systems are used for project planning of this type of controller system for example.

### SUMMARY OF INVENTION

The underlying object of the invention is thus to create an improved method for wiring automation functions in a system and an improved method for requesting and modifying wiring information and a corresponding system server computer and a corresponding computer system.

The object underlying the invention will be achieved with the features of the independent patent claims in each case.

Preferred embodiments of the invention are specified in the dependent patent claims.

The invention allows the wiring of automation functions in a system to be specified by means of a file in a Markup Language. The Markup Language involved can for example be the hypertext markup language (HTML) or the extended-markup-language (XML).

A corresponding file is stored on a system server and interpreted there. The System server computer then implements the wiring of the components of the system specified in the file by sending the corresponding commands to the components involved.

In a preferred embodiment of the invention the file is created in a Markup Language to describe the wiring of automation functions in a design system for example, this being referred to as an engineering system. The file will then be transmitted via a communication link, for example via a network which operates in accordance with a TCP/IP protocol, to the system server computer.

In accordance with a further preferred embodiment of the invention the wiring information of an existing system can be requested by the system server. To do this the system server computer requests from the components of the system in each case their wiring to the other components of the system. The system server computer then integrates the information collected in this way in a Markup Language file. This can be transmitted via a network to a client computer for example.

In a further preferred embodiment of the invention the file on the client computer is shown graphically in order to visualize the wiring of the automation function for a user. This can be done on the client side by means of a normal browser program, e.g. Microsoft Explorer or Netscape Navigator.

In accordance with a further preferred exemplary embodiment of the invention the file can be edited on the client side to modify wiring information. After the wiring information has been modified by editing the file this information is sent back to the system server computer by the client computer, interpreted there and executed in order to implement the modified wiring information.

The invention is especially advantageous in that it allows a flexible implementation of the wiring of automation functions and does this without proprietary protocols and file formats and without the necessity for hardware wiring of the components of the system.

Associated with this is the option of requesting the current wiring information. This request option is especially advantageous if toe system allows components of the system to also be locally reconfigured, that is without the aid of the system server computer. In order to obtain a current image of the wiring information at a given point in time, the method in accordance with the invention forrequesting the wiring information is especially advantageous.

Because of this flexibility it is then also possible to edit the information obtained about the wiring of the components in order to make modifications. A conventional browser program can be used for editing for example. The modified wiring information is then implemented in its turn by transmitting the modified file to the system server computer where the file is interpreted and the modified wiring is implemented.

### BRIEF DESCRIPTION OF THE DRAWINGS

Preferred exemplary embodiments are explained below in more detail with reference to the drawings. The drawings show

FIG. 1 a block diagram of a hardware controller system with remote access in accordance with the prior art,

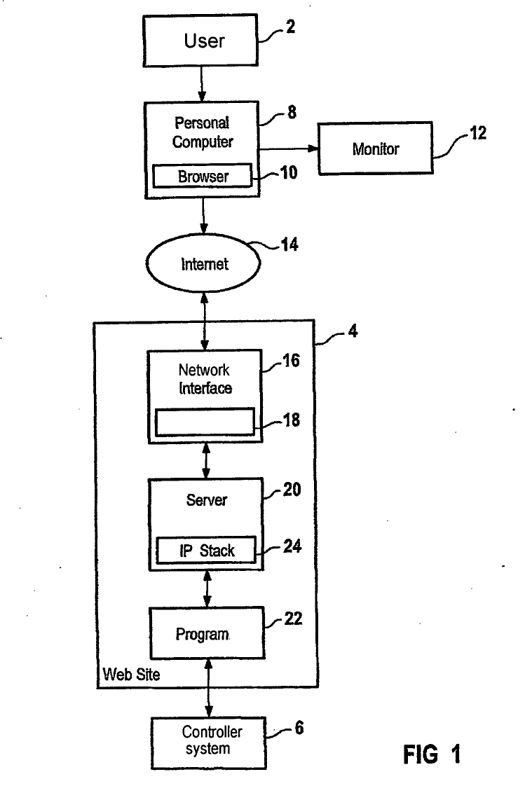

FIG. 2 a block diagram of an embodiment of one of the inventive systems.

### DETAILED DESCRIPTION OF THE DRAWINGS

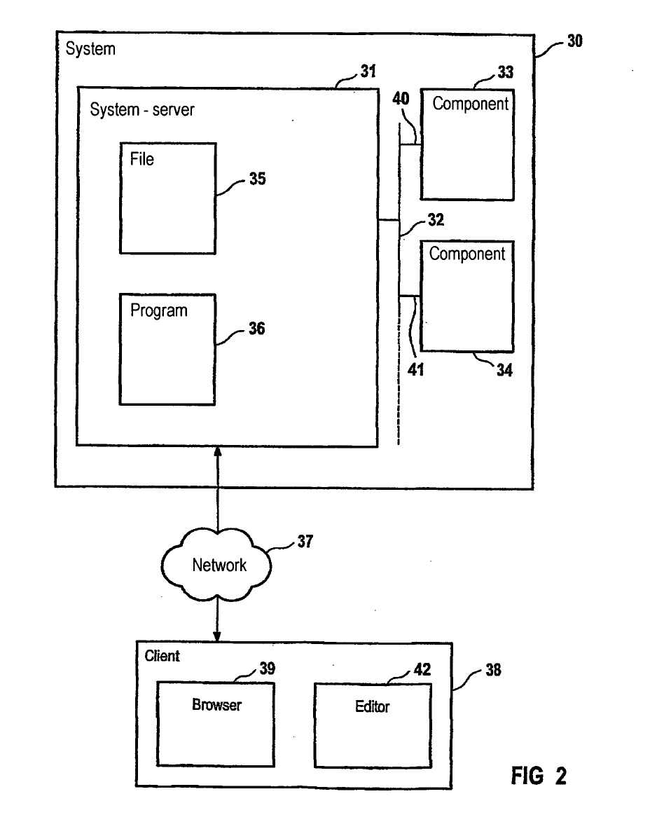

FIG. 2 shows a system 30 with a system server computer 31. The system server computer 31 is connected via a network 32 to various components of the system. To make the diagram clearer only the components 33 and 34 of the system which are connected to the network 32 are shown in FIG. 2. Thus the system server computer 31 can communicate via the network 32 with each of the components 33 and 34 and the components 33 and 34 can also communicate directly with each other.

Network 32 can for example be a Profibus, Field Bus, Ethernet, industrial Ethernet or FireWire network.

A file 35 is stored on the system server computer 31. The file 35 is a Markup Language file, for example html or XML. File 35 contains a description in the Markup Language in respect of the wiring of automation functions in the system 30, i.e. a description of the way in which the components of the system interact with each other, especially how the inputs and outputs of the components are assigned to each other.

Furthermore the system server computer 31 has a program 36. The program 36 is used for interpretation of the file 35 and compiles the information contained in the file 35 for wiring the automation functions into commands which can be sent over a network 32 to the components of the system, especially the components 33 and 34. The commands are used for implementing the wiring specified in the file 35.

The system server computer 31 can be connected via a network 37 with a client computer 38. The client computer 38 has a browser program 39, which can for example be a normal browser such as Microsoft Explorer or Netscape Navigator. Preferably the browser program 39 is also suitable for displaying XML files.

The file 35 can be created using a design system, known as an engineering system, on which the project planning for the system was undertaken. This design system can run on client computer 38.

After the provision of file 35 on the client computer 38, the file 35 is transmitted over the network 37 to the system server computer 31 and stored there. The program 36 is then started and interprets the file 35. The program 36 thus reads out the specification of the wiring of automation functions of the system from the file 35 andgenerates corresponding commands for the components of the system to implement the wiring. Thereafter normal system operation can be started.

For example the file 35 can specify that an output 40 of the component 33 is to be linked to an input 41 of the component 34. For example component 33 could be a measured value generator, e.g. a temperature sensor, rev counter, pressure sensor or such like which continuously outputs measurement signals a specific intervals.

These measurement signals are to be permanently assigned to input 41 of component 34, i.e. transmitted directly from the output 40 in a specific consecutive communication cycles to the input 41 via the network 32 without going through the system server computer 31. The component 34 can for example be a closed-loop controller which constantly needs the measured values involved for control.

If the file 35 includes such a specification for assigning the output 40 of the component 33 To the input 41 of the component 34 this information is read by the program 36. The program 36 then generates a command to component 33 to notify Components 33 that the measured values generated by component 33 are to be sent via its output 40 to the input 41 of the component 34. Depending on the type of network 32 used it can be necessary for the programme 36 to also generate a command for the component 34 to notify the component 34 that this is receiving at its input 41 measured values from a component 33 or its output 40.

By means of the commands generated by the program 36 and transmitted via the network 32 to the component 33 and if necessary 34 the components 33 and 34 are initialized. The same procedures are followed for the other components of system 30.

For operation of the system 30 it is possible with a few components of the system to modify their operating mode and/or operating parameters. This can be done it without involving the system server computer 31.

The current wiring information of the components of the system 30 can be retrieved by the client computer 38. To do this an appropriate URL (Uniform Resource Locator) is entered into the browser 39 and a connection is established via the network 37 to the system server computer 31.

The program 36 is then started. The program 36 then generates commands for all components of the system the 30, especially for the components 33 and 34 to request their relevant wiring information. For example the component 33 will send a response message to this request by the network 32 to the system server computer 31, after which the output 40 of the component 33 is assigned to the input 41 of component 34. Should this assignment have changed in the interim, the corresponding changed assignment information will be transmitted in the response message.

On the basis of the response messages of the individual components of the system 30, the program 36 collects the complete wiring information of the automation functions of system 30. On the basis of this wiring information the program 36 generates an updated file 35 in a Markup Language which will be transmitted via the network 37 to the client computer 38. The updated file 35 can then be shown on the browser 39 of the client computer 38, so that the user is given a visual display of the wiring information.

Particularly advantageous here is that the visualization can occur in a wide variety of ways, using tables or graphics, and is also independent of the way in which the system 30 is implemented.

This further allows the wiring information of the system 30 to be modified. To do this the updated file 35 is opened on the client computer 38 with an editor 42. The editor 42 is used to edit the file 35 to modify the wiring of functions in the system 30.

To do this the file 35 will be modified in the editor 42 by a user or by an engineering system in accordance with the desired modification of the wiring information. The file 35 modified in this way will then be returned by the client computer 38 via network 37 To the system server computer 31.

The program 36 will be started in its turn which interprets the file 35 and generates the corresponding commands for implementing the modified wiring information. It is particularly advantageous here that the editing can be done independently of the engineering tool used. In particular the editing can be done in a wide variety of ways, for example by modifying the entries in a table or graphic or also via a graphical user interface. A further advantage is that the visualization of the wiring information of the automation functions is independent of the system realization in system 31.

To summarize, the invention relates to a method and its system for wiring of automation functions in a system. To do this a file in a Markup Language is transmitted by a client program via a network to the system server computer. The file describes the wiring of automation functions in a Markup Language. The file is interpreted by a programme of the system server computer. The program then generates the corresponding commands for the components which are transmitted via the network. By means of these commands the wiring specified by the file is implemented in the components. It is further possible to edit the file on the client computer in order to make modifications to the wiring.

1. A method for linking automation functions in a system having at least a first and a second system component as well as at least one client computer and a system server computer wherein the client computer and the system server computer are linked by a communication link, and the linking of automation functions involves the assignment of an output of the first system component of the system to an input of the second system component of the system, comprising:
specifying the linking of automation functions by a file in a markup language, on the client computer or the system server computer;
transmitting the file in the markup language to the system server computer;
storing the file in the markup language on the system server computer;
interpreting the file in the markup language by the system server computer; and
automatically implementing corresponding wiring linking by transmission of the corresponding commands to the components involved of the system by the system server computer.

2. A method in accordance with claim 1, wherein the first system component involved is a measuring transducer.

3. A method in accordance with claim 1, wherein the assignment is made by transmitting a corresponding command from the system server computer at least to a first component.

4. A method in accordance with claim 1, further comprising linking the components of the system with the system server computer by a network,

5. A method in accordance with claim 1, wherein the file is created on a design system or an engineering system of the client computer.

6. A method in accordance with claim 1, further steps comprising:
requesting linking information of automation functions in a system from the client computer to the system server computer;
requesting linking information of the components of the system by the system server computer;
creating the file describing the linking of automation functions in a markup language by the system server computer; and
transmitting of the file to the client computer.

7. A method in accordance with claim 6, further comprising: requesting the linking information by the system server computer via a network from the components of the system.

8. A method for modifying linking information of an automation function in a system by a client computer comprising:
requesting linking information of automation functions in a system from the client computer to the system server computer;
requesting linking information of the components of the system by the system server computer;
creating the file describing the linking of automation functions in a markup language by the system server computer;
transmitting the file to the client computer;
editing the file;
transmitting the edited file with the modified linking information to the system server computer;
interpreting the edited file with the modified linking information by the system server computer; and
automatically implementing the modified linking by transmission of the corresponding commands to the components involved of the system by the system server computer.

9. A system server computer for use in a system comprising:
a central processor unit;
a mechanism for communicating with system components; and
a mechanism for interpretation of a file in a markup language for executing a method, for linking automation functions in a system, the system comprising at least a first and a second system component as well as at least one client computer and a system server computer, wherein the client computer and the system server computer are linked by a communication link, and wherein the linking of automation functions involves the assignment of an output of the first system component of the system to an input of the second system component of the system, the method comprising:
specifying the linking of automation functions by a file in a markup language on the client computer or the system server computer;
transmitting the file in the markup language to the system server computer;
storing the file in the markup language on the system server computer;
interpreting the file in the markup language by the system server computer; and
automatically implementing of corresponding linking by transmission of the corresponding commands to the components involved of the system by the system server computer.

10. A computer system comprising:
a system server computer having a mechanism for interpreting a file in a markup language and adapted to cooperate with a client computer; and
a client computer having a mechanism for interpreting a file in a markup language for executing a method for linking automation functions in a system, the system comprising at least a first and a second system component as well as at least one client computer and a system server computer, wherein the client computer and the system server computer are linked by a communication link, and wherein the linking of automation functions involving the assignment of an output of the first system component of the system to an input of the second system component of the system, the method comprising:
specifying the linking of automation functions by a file in a markup language on the client computer or the system server computer;
transmitting the file in the markup language to the system server computer;
storing the file in the markup language on the system server computer;
interpreting the file in the markup language by the system server computer; and
automatically implementing of corresponding linking by transmission of the corresponding commands to the components involved of the system by the system server computer.

11. A computer program product for executing a method, for linking automation functions in a system, the system comprising at least a first and a second system component as well as at least one client computer and a system server computer, wherein the client computer and the system server computer are linked by a communication link, and wherein the linking of automation functions involving the assignment of an output of the first system component of the system to an input of the second system component of the system, the method comprising:
specifying the linking of automation functions by a file in a markup language on the client computer or the system server computer;
transmitting the file in the markup language to the system server computer;
storing the file in the markup language on the system server computer;
interpreting the file in the markup language by the system server computer; and
automatically implementing of corresponding linking by transmission of the corresponding commands to the components involved of the system by the system server computer.

12. A method in accordance with claim 1, wherein the markup language is HTML or XML.

13. A method in accordance with claim 1, wherein the measuring transducer is a temperature sensor, a speed regulator or a humidity sensor.

14. A method in accordance with claim 1, wherein the second component is a closed-loop controller.

15. A method in accordance with claim 2, wherein the assignment is made by transmitting a corresponding command from the system server computer at least to a first component.

16. A method in accordance with claim 2, further comprising: linking the components of the system with the system server computer by a network.

17. A method in accordance with claim 3, further comprising: linking the components of the system with the system server computer by a network.

18. A method in accordance with claim 4, wherein the network is a Profibus or a Field Bus or a Ethernet or an industrial Ethernet or a FireWire network.

19. A method in accordance with claim 16, wherein the network is a Profibus or a Field Bus or a Ethernet or an industrial Ethernet or a FireWire network.

20. A method in accordance with claim 17, wherein the network is a Profibus or a Field Bus or a Ethernet or an industrial Ethernet or a FireWire network.

21. A method in accordance with claim 2, wherein the file is created on a design system or an engineering system of the client computer.

22. A method in accordance with claim 3, wherein the file is created on a design system or an engineering system of the client computer.

23. A method in accordance with claim 4, wherein the file is created on a design system or an engineering system of the client computer.
